(19) United States
(12) Patent Application Publication
(10) Pub. No.: US 2008/0218915 A1
(43) Pub. Date: Sep. 11, 2008

(54) Tunnel Magnetoresistive Effect Element With Lower Noise and Thin-Film Magnet Head Having the Element

(75) Inventors: Takumi Uesugi, Tokyo (JP); Satoshi Miura, Tokyo (JP); Tetsuro Sasaki, Tokyo (JP); Takeo Kagami, Tokyo (JP); Kei Hirata, Tokyo (JP)

Correspondence Address: FROMMER LAWRENCE & HAUG, 745 FIFTH AVENUE- 10TH FL., NEW YORK, NY, 10151, US

(73) Assignee: TDK CORPORATION, Tokyo (JP)

(21) Appl. No.: 11/681,937

(22) Filed: Mar. 5, 2007

(51) Int. Cl. G11B 5/127

(52) U.S. Cl. 360/328

(57) ABSTRACT

Provided is a TMR effect element having no special structures needing much man-hour cost for the formation, in which the high temperature noise and the low temperature noise are suppressed and a sufficiently high resistance-change ratio is provided. The TMR effect element comprises: a tunnel barrier layer formed by oxidizing a base film; and two ferromagnetic layers stacked so as to sandwich the tunnel barrier layer, the base film having a film thickness larger than a film thickness at which a resistance-change ratio of the TMR effect element indicates a maximum value. Here, in the case that the base film is an aluminum film, the film thickness of the aluminum film is preferably in the range of 0.50 nm to 1.5 nm.

### BACKGROUND OF THE INVENTION

1. Field of the Invention

The present invention relates to a tunnel magnetoresistive (TMR) effect element that provides an output based on resistance change according to the intensity of a signal magnetic field, a thin-film magnetic head including the TMR effect element, a head gimbal assembly (HGA) provided with the thin-film magnetic head, and a magnetic recording/reproducing apparatus provided with the HGA. Especially, the present invention relates to a manufacturing method of the TMR effect element.

2. Description of the Related Art

As magnetic recording/reproducing apparatuses, in particular magnetic disk drive apparatuses, increase in capacity and reduce in size, thin-film magnetic heads are required to have higher sensitivity and larger output. To respond to the requirement, a tunnel magnetoresistive (TMR) effect, which is expected to show extremely high resistance-change ratio, attracts attention, and actually thin-film magnetic heads having the TMR effect element as a read head element for reading data are being intensively developed.

The TMR effect element has a magnetization-pinned layer (pinned layer) in which the magnetization direction is fixed, and a magnetization-free layer (free layer) in which the magnetization direction can change according to an applied magnetic field, and has a structure in which a tunnel barrier layer as an energy barrier in the tunneling effect is sandwiched between the pinned layer and the free layer. The tunnel barrier layer is usually a metal-oxide layer, and therefore, the TMR effect element has an element resistance higher than those of other magnetoresistive (MR) effect elements such as an anisotropic magnetoresistive (AMR) effect element and a giant magnetoresistive (GMR) effect element. A considerably higher resistance of the TMR effect element is likely to increase a shot noise derived from random motions of electrons in the element, to degrade the signal-to-noise (S/N) ratio of the element output.

One measure for decreasing the element resistance may be to reduce the thickness of the tunnel barrier layer. However, an outright reduction of the layer thickness causes the corresponding decrease in the resistance-change ratio. As the measure for both of high resistance-change ratio and low element resistance, for example, Japanese Patent Publication No. 2000-322714A describes a structure provided with a noble metal between a ferromagnetic layer and the a tunnel barrier layer. Further, for example, Japanese Patent Publication No. 2000-266566A describes a structure provided with a non-magnetic layer such as III-V intermetallic compound layer at the position of a tunnel barrier layer.

As the conventional measure without using the above-described special structure needing much man-hour cost for the formation, the thickness of the tunnel barrier layer has been adjusted so that the ratio of the resistance-change ratio and the sheet-resistance of the element becomes as high as possible. Generally, the higher the ratio is, the larger the element output becomes. Here, the sheet-resistance is defined as a product of the element resistance in the layer thickness direction and the area of the layer surface of the element. In fact, used is a tunnel barrier layer with a thickness at which the resistance-change ratio indicates a maximum value or with smaller thickness than the just-described thickness. As a result, in some cases, a new noise may occur due to the formation of pinholes. As the measure against the new noise, the elements are screened in the formation step, and elements showing a noise in a predetermined degree or more are excluded.

However, even if the screening is performed, there have been elements that show a considerably large noise under the condition of high environmental temperature, for example, approximately 85 to 100° C. or of low environmental temperature, for example, approximately −10 to 0° C. The degree of the noise under the condition of high or low environmental temperature (high temperature noise or low temperature noise) has been difficult to be judged in the head manufacturing process.

### BRIEF SUMMARY OF THE INVENTION

Therefore, an object of the present invention is to provide a TMR effect element having no special structures needing much man-hour cost for the formation, in which the high temperature noise and the low temperature noise are suppressed and a sufficiently high resistance-change ratio is provided, a thin-film magnetic head with the TMR effect element, an HGA including the thin-film magnetic head, and a magnetic recording/reproducing apparatus including the HGA.

Another object of the present invention is to provide a manufacturing method of a TMR effect element having no special structures needing much man-hour cost for the formation, in which the high temperature noise and the low temperature noise are suppressed and a sufficiently high resistance-change ratio is provided.

Before describing the present invention, terms used herein will be defined. In a multilayer structure formed on/above the element formation surface of a substrate in a TMR effect element or a thin-film magnetic head, a layer or a portion of the layer located closer to the substrate than a standard layer is referred to as being located “lower” than, “beneath” or “below” the standard layer, and a layer or a portion of the layer located on the stacking direction side in relation to a standard layer is referred to as being located “upper” than, “on” or “above” the standard layer.

According to the present invention, a TMR effect element is provided, which comprises: a tunnel barrier layer formed by oxidizing a base film; and two ferromagnetic layers stacked so as to sandwich the tunnel barrier layer, the base film having a film thickness larger than a film thickness at which a resistance-change ratio of the TMR effect element indicates a maximum value.

In the above-described TMR effect element, it is preferable that the base film is an aluminum film and a film thickness of the aluminum film is in the range of 0.50 nanometer to 1.5 nanometer. It is also preferable that the base film is a magnesium film and a film thickness of the magnesium film is in the range of 0.60 nanometer to 1.5 nanometer. Further, the base film is also preferably a film including at least one element selected from a group of titanium, hafnium, Zinc, tantalum, zirconium, silicon, molybdenum, tungsten, tin, nickel, gadolinium, niobium, gallium and germanium. Furthermore, the tunnel barrier layer preferably has a non-oxidized or insufficiently oxidized layer in the lower end portion of the tunnel barrier layer.

In the TMR effect element according to the present invention, the high temperature noise and the low temperature noise are suppressed without using no special structures needing much man-hour cost for the formation, and the resistance-change ratio shows a sufficiently large value though slightly decreased compared with the maximum value.

According to the present invention, a thin-film magnetic head is further provided, which comprises: a substrate; and the above-described TMR effect element for reading data formed on/above an element formation surface of the substrate.

According to the present invention, an HGA is further provided, which comprises: the above-described thin-film magnetic head; signal lines for the TMR effect element; and a support means for supporting the thin-film magnetic head.

According to the present invention, a magnetic recording/reproducing apparatus is further provided, which comprises: at least one HGA described above; at least one magnetic recording medium; and a recording/reproducing means for controlling read and write operations of the thin-film magnetic head to the at least one magnetic recording medium.

According to the present invention, a manufacturing method of a TMR effect element is further provided, which comprises steps of: forming a first ferromagnetic layer on/above an element formation surface of a substrate; forming a base film having a film thickness larger than a film thickness at which a resistance-change ratio of the TMR effect element indicates a maximum value, on the first ferromagnetic layer; forming a tunnel barrier layer by oxidizing the base film; and forming a second ferromagnetic layer on the tunnel barrier layer.

In the above-described manufacturing method, an aluminum film with a film thickness in the range of 0.50 nanometer to 1.5 nanometer is preferably formed as the base film. Or a magnesium film with a film thickness in the range of 0.60 nanometer to 1.5 nanometer is preferably formed as the base film. Further, it is also preferable that a film including at least one element selected from a group of titanium, hafnium, Zinc, tantalum, zirconium, silicon, molybdenum, tungsten, tin, nickel, gadolinium, niobium, gallium or germanium is formed as the base film.

By using the manufacturing method according to the present invention, a TMR effect element can be provided, in which the high temperature noise and the low temperature noise are suppressed and the resistance-change ratio shows a sufficiently large value without forming no special structures needing much man-hour cost.

Further objects and advantages of the present invention will be apparent from the following description of preferred embodiments of the invention as illustrated in the accompanying figures. In each figure, the same element as that shown in other figure is indicated by the same reference numeral. Further, the ratio of dimensions within an element and between elements becomes arbitrary for viewability.

### BRIEF DESCRIPTION OF THE SEVERAL VIEWS OF THE DRAWINGS

FIG. 1 shows perspective views schematically illustrating a configuration of one embodiment of a magnetic recording/reproducing apparatus, an HGA and a thin-film magnetic head according to the present invention;

FIG. 2 shows a cross-sectional view taken along line a-a in FIG. 1 schematically illustrating a main portion of the thin-film magnetic head 21;

FIG. 3 shows a cross-sectional view taken along line b-b in FIG. 2 viewed from the head end surface side, schematically illustrating a layered structure of an embodiment of the TMR effect multilayer;

FIG. 4a shows a flow chart schematically illustrating an embodiment of the manufacturing method of a TMR effect element according to the present invention;

FIG. 4b shows cross-sectional views for explaining the oxidization process of the base film (step 4) in the flow chart of FIG. 4a;

FIG. 5a shows a graph of the relation between the film thickness t_{MF} of the Al base film and the resistance-change ratio, whose data are shown in Table 1;

FIG. 5b shows a graph of the relation between the film thickness t_{MF} of the Al base film and the ratio of the resistance-change ratio/the sheet-resistance, whose data are also shown in Table 1;

FIGS. 6a to 6c show cross-sectional views of the tunnel barrier layer, schematically explaining the considered mechanism;

FIG. 7a shows a graph of the relation between the film thickness t_{MF} of the Mg base film and the resistance-change ratio, whose data are shown in Table 3;

FIG. 7b shows a graph of the relation between the film thickness t_{MF} of the Mg base film and the ratio of the resistance-change ratio/the sheet-resistance, whose data are also shown in Table 3; and

FIG. 8 shows a graph of the data shown in Table 4, that is, of the relation between the film thickness t_{MF} of the Mg base film and the percent HTN defective.

### DETAILED DESCRIPTION OF THE INVENTION

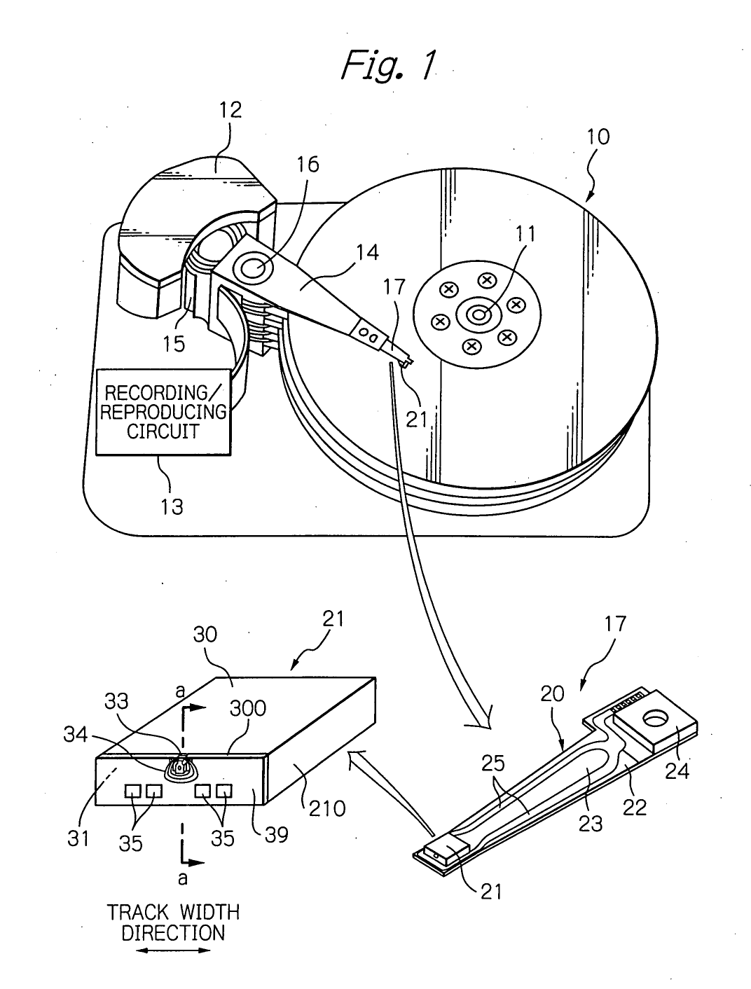

FIG. 1 shows perspective views schematically illustrating a configuration of one embodiment of a magnetic recording/reproducing apparatus, an HGA and a thin-film magnetic head according to the present invention. In magnified views of the HGA and the thin-film magnetic head of FIG. 1, the side opposed to a magnetic disk is turned upward.

The magnetic recording/reproducing apparatus shown in FIG. 1 is a magnetic disk drive apparatus, which includes multiple magnetic disks 10 as magnetic recording media that rotate about a spindle of a spindle motor 11, an assembly carriage device 12 provided with multiple drive arms 14, HGAs 17 each of which is attached on the end portion of each drive arm 14 and provided with a thin-film magnetic head (slider) 21, and a recording/reproducing circuit 13 for controlling read/write operations.

The assembly carriage device 12 is provided for positioning the thin-film magnetic head 21 above a track formed on the magnetic disk 10. In the device 12, the drive arms 14 are stacked along a pivot bearing axis 16 and are capable of angular-pivoting about the axis 16 driven by a voice coil motor (VCM) 15. The numbers of magnetic disks 10, drive arms 14, HGAs 17, and thin-film magnetic heads 21 may be one.

While not shown, the recording/reproducing circuit 13 includes a recording/reproducing control LSI, a write gate for receiving data to be recorded from the recording/reproducing control LSI, an write circuit for outputting a signal from the write gate to an electromagnetic coil element for writing data, which will be described later, a constant current circuit for supplying a sense current to a TMR effect element for reading data, which will also be described later, an amplifier for amplifying output voltage from the TMR effect element, and a demodulator circuit for demodulating the amplified output voltage and outputting reproduced data to the recording/reproducing control LSI.

Also as shown in FIG. 1, in the HGA 17, the thin-film magnetic head 21 is fixed and supported on the end portion of a suspension 20 in such a way to face the surface of each magnetic disk 10 with a predetermined spacing (flying height). And one end of a wiring member 25 is connected to electrodes of the thin-film magnetic head 21.

The suspension 20 includes a load beam 22, an flexure 23 with elasticity fixed on the load beam 22, a base plate 24 provided on the base portion of the load beam 22, and a wiring member 25 that is provided on the flexure 23 and consists of lead conductors as signal lines and connection pads electrically connected to both ends of the lead conductors. While not shown, a head drive IC chip may be attached at some midpoints of the suspension 20.

Also as shown in FIG. 1, the thin-film magnetic head 21 includes: a slider substrate 210 having an air bearing surface (ABS) 30 processed so as to provide an appropriate flying height and an element formation surface 31; a TMR effect element 33 as a read head element for reading data and an electromagnetic coil element 34 as a write head element for writing data which are formed on/above the element formation surface 31; an overcoat layer 39 formed so as to cover the TMR effect element 33 and the electromagnetic coil element 34; and four signal electrodes 35 exposed in the upper surface of the overcoat layer 39. Here, the ABS 30 of the thin-film magnetic head 21 is opposed to the magnetic disk 10. And respective two of the four signal electrodes 35 are connected to the TMR effect element 33 and the electromagnetic coil element 34.

One ends of the TMR effect element 33 and the electromagnetic coil element 34 reach the head end surface 300 on the ABS 30 side. These ends face the surface of the magnetic disk 10, and then, a read operation is performed by sensing a signal magnetic field from the disk 10, and a write operation is performed by applying a write magnetic field to the disk 10. A predetermined area of the head end surface 300 that these ends reach may be coated with diamond like carbon (DLC), etc. as an extremely thin protective film.

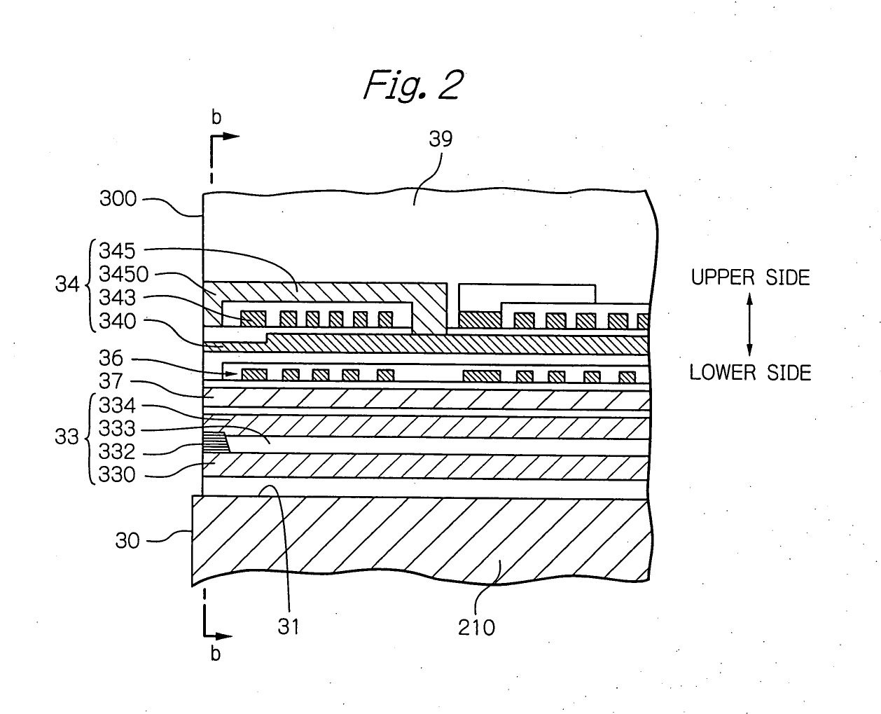

FIG. 2 shows a cross-sectional view taken along line a-a in FIG. 1 schematically illustrating a main portion of the thin-film magnetic head 21. In the figure, the electromagnetic coil element 34 is for perpendicular magnetic recording. However, it may be an electromagnetic coil element for longitudinal magnetic recording, which has a write coil layer and upper and lower magnetic pole layers whose end portions on the head end surface side pinch a write gap layer.

In FIG. 2, the TMR effect element 33 includes a TMR effect multilayer 332, an insulating layer 333 covering at least the rear side surface of the multilayer 332, and a lower electrode layer 330 and an upper electrode layer 334 which sandwich the TMR effect multilayer 332 and the insulating layer 333. The TMR effect multilayer 332 senses a signal field from the magnetic disk with very high sensitivity. The upper and lower electrode layers 334 and 330 are electrodes for applying a sense current in the direction perpendicular to the stacking plane of the TMR effect multilayer 332, and further play a role of shielding external magnetic fields that cause noise for the TMR effect multilayer 332.

Also as shown in FIG. 2, the electromagnetic coil element 34 is for perpendicular magnetic recording in the present embodiment, and includes a main magnetic pole layer 340 formed of a soft-magnetic material such as NiFe (Permalloy), CoFeNi, CoFe, FeN or FeZrN, a write coil layer 343 formed of an conductive material such as Cu (copper), and an auxiliary magnetic pole layer 345 formed of a soft-magnetic material such as NiFe (Permalloy), CoFeNi, CoFe, FeN or FeZrN. The main magnetic pole layer 340 is a magnetic path for converging and guiding a magnetic flux excited by a write current flowing through the write coil layer 343 to the record layer of the magnetic disk 10. The length in the stacking direction (thickness) of the end portion on the head end surface 300 side of the main magnetic pole layer 340 becomes smaller than that of the other portions. As a result, the main magnetic pole layer 340 can generate fine write fields corresponding to higher density recording. The write coil layer 343 has a monolayer structure in FIG. 2, however, may have a two or more layered structure or a helical coil shape. Further, the number of turns of the write coil layer 343 is not limited to that shown in FIG. 2.

The end portion in the head end surface 300 side of the auxiliary magnetic pole layer 345 becomes a trailing shield portion 3450 that has a length in the stacking direction (thickness) larger than that of the other portions. The trailing shield portion 3450 causes a magnetic field gradient between the end portion of the trailing shield portion 3450 and the end portion of the main magnetic pole layer 340 to be steeper. As a result, a jitter of signal outputs becomes smaller, and therefore, an error rate during reading can be reduced.

Further, in the present embodiment, a backing coil portion 36 and an inter-element shield layer 37 are provided between the TMR effect element 33 and the electromagnetic coil element 34. The backing coil portion 36 suppresses a wide area adjacent-track erase (WATE) behavior, which is an unwanted write or erase operation to the magnetic disk, by generating a magnetic flux for negating the magnetic flux loop that arises from the electromagnetic coil element 34 through the upper and lower electrode layers 334 and 330 of the TMR effect element 33.

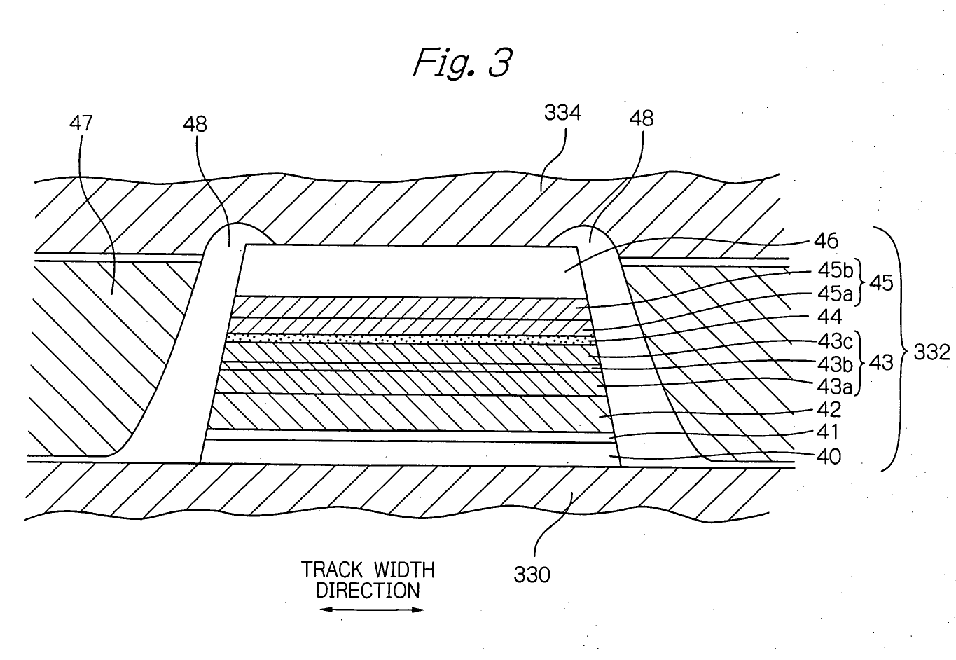

FIG. 3 shows a cross-sectional view taken along line b-b in FIG. 2 viewed from the head end surface 300 side, schematically illustrating a layered structure of an embodiment of the TMR effect multilayer 332.

In FIG. 3, the TMR effect multilayer 332 has a multilayered structure in which a lower metal layer 40, a base layer 41, an antiferromagnetic layer 42 formed of an antiferromagnetic material, a pinned layer 43 formed of a ferromagnetic material, a tunnel barrier layer 44 formed of an oxide, a free layer 45 formed of a ferromagnetic material, and an upper metal layer 46 are stacked sequentially.

The lower metal layer 40 is provided on the lower electrode layer 330, and electrically connects the TMR effect multilayer 332 to the lower electrode layer 330. Further, the upper metal layer 46 electrically connects the TMR effect multilayer 332 to the upper electrode layer 334 by providing the upper electrode layer 334 on the upper metal layer 46. Therefore, during detecting a signal field, a sense current flows in the direction perpendicular to the surface of each stacked layer of the TMR effect multilayer 332.

The antiferromagnetic layer 42 is provided above the lower metal layer 40 through the base layer 41. The pinned layer 43 is provided on the antiferromagnetic layer 42, and has namely a synthetic-ferri-pinned structure in which a first ferromagnetic film 43a, a non-magnetic film 43b and a second ferromagnetic film 43c are sequentially stacked from the antiferromagnetic layer 42 side. The first ferromagnetic film 43a receives an exchange bias field due to the exchange interaction with the antiferromagnetic layer 42. As a result, the whole magnetization of the pinned layer 43 is stably fixed.

The free layer 45, which is provided on the tunnel barrier layer 44, has a two-layered structure in which a high polarizability film 45a and a soft-magnetic film 45b are sequentially stacked from the tunnel barrier layer 44 side. The magnetization of the free layer 45 makes a ferromagnetic tunnel coupling together with the magnetization of the pinned layer 43 with the tunnel barrier layer 44 as a barrier of the tunnel effect. Thus, when the magnetization direction of the free layer 45 changes in response to a signal field, a tunnel current increases/decreases due to the variation in the state densities of up and down spin bands of the pinned layer 43 and the free layer 45, and therefore, the electric resistance of the TMR effect multilayer 332 changes. The measurement of this resistance change enables a weak and local signal field to be surely detected with high sensitivity.

The tunnel barrier layer 44 according to the present invention has a layer thickness t_{ML} larger than a layer thickness t_{ML0} at which the resistance-change ratio of the TMR effect element 33 indicates a maximum value, as described later in detail. And the tunnel barrier layer 44 may be formed of a layer obtained by oxidizing a base film made of at least one element selected from the group of, for example, Al (aluminum), Mg (magnesium), Ti (titanium), Hf (hafnium), Zn (Zinc), Ta (tantalum), Zr (zirconium), Si (silicon), Mo (molybdenum), W (tungsten), Sn (tin), Ni (nickel), Gd (gadolinium), Nb (niobium), Ga (gallium) or Ge (germanium). The oxidization is performed by exposing the upper surface of the base film in an atmosphere with a predetermined O₂ (oxygen) partial pressure. Going through the oxidization, the layer thickness t_{ML} of the formed tunnel barrier layer 44 becomes one and a half to four times (1.5 to 4 times) larger than a film thickness t_{MF} of the base film before the oxidization, and is almost proportional to the film thickness t_{MF}. Here, a film thickness of the base film is defined to be t_{MF0}, at which the layer thickness t_{ML0} of the tunnel barrier layer 44 is obtained, which realizes the maximum resistance-change ratio of the TMR effect element 33. Then, to realize the layer thickness of the tunnel barrier layer 44 larger than the layer thickness t_{ML0}, it is an essential condition to set the film thickness t_{MF} of the base film to be larger than the film thickness t_{MF0}.

In the case that the tunnel barrier layer 44 is an Al-film-oxidized layer, the film thickness of the Al film before the oxidization is set to be in the range of 0.50 nm (nanometer) to 1.5 nm, as described later in detail using practical examples. In the case that the tunnel barrier layer 44 is a Mg-film-oxidized layer, the film thickness of the Mg film before the oxidization is set to be in the range of 0.60 nm to 1.5 nm.

By applying the tunnel barrier layer with the above-described structure, realized is a TMR effect element having no special structures needing much man-hour cost for the formation, in which the high temperature noise and the low temperature noise are suppressed and a sufficiently high resistance-change ratio is provided, as described later in detail.

As a matter of course, the mode of each layer of the TMR effect multilayer 332 is not limited to the above-described one. For example, the pinned layer 43 may have a monolayer structure of a ferromagnetic film, or a multilayered structure with other number of layers. Further, the free layer 45 may have a monolayer structure without a high polarizability film, or may have a more-than-two-layered structure including a film for adjusting magnetostriction. The antiferromagnetic layer, the pinned layer, the tunnel barrier layer and the free layer may be stacked in the reverse order, that is, the free layer, the tunnel barrier layer, the pinned layer and the antiferromagnetic layer may be stacked in this order. When the pinned layer, the tunnel barrier layer and the free layer may be stacked in this order, the pinned layer and the free layer become the first and the second ferromagnetic layers respectively. On the other hand, when the free layer, the tunnel barrier layer and the pinned layer may be stacked in this order, the free layer and the pinned layer become the first and the second ferromagnetic layers respectively.

Also as shown in FIG. 3, hard bias layers 47 made of a hard-magnetic material may be provided on both sides in the track width direction of at least the free layer 45 through insulating layers 48. Further, though not shown in the figure, an in-stack bias multilayer may be provided, in which a bias non-magnetic layer, a bias ferromagnetic layer and a bias antiferromagnetic layer are sequentially stacked between the free layer 45 and the upper metal layer 46. These bias means promote the stability of magnetic domains in the free layer 45 by applying a bias field to the free layer 45, to realize an stable linear output of the TMR effect element.

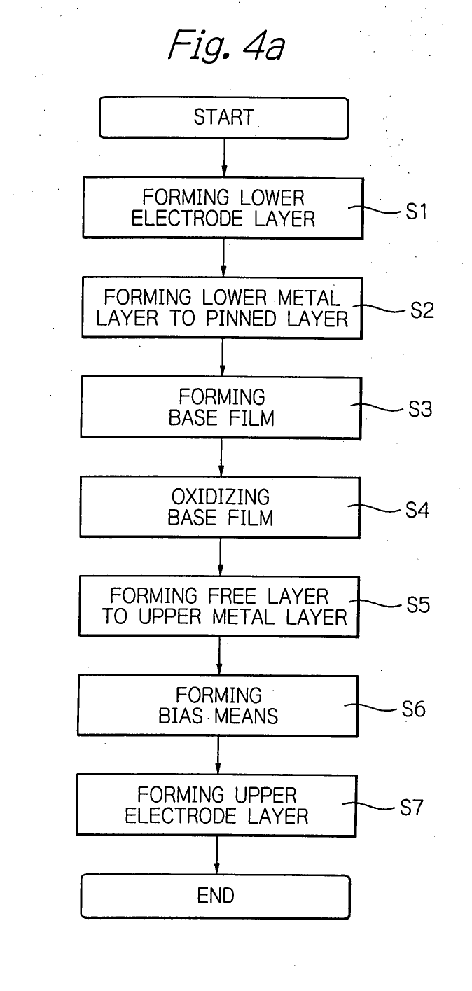

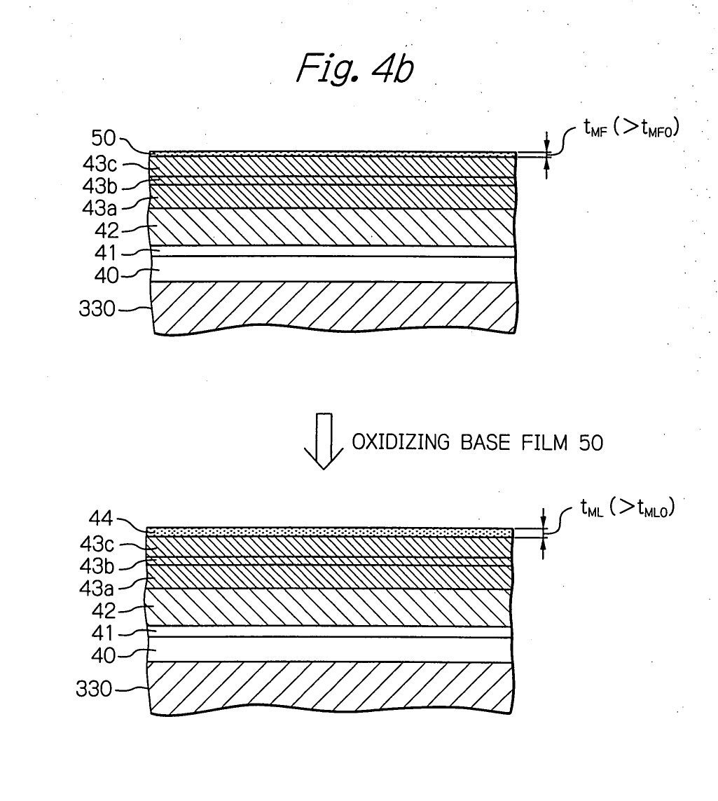

FIG. 4a shows a flow chart schematically illustrating an embodiment of the manufacturing method of a TMR effect element according to the present invention. And FIG. 4b shows cross-sectional views for explaining the oxidization process of the base film (step 4) in the flow chart of FIG. 4a.

According to FIG. 4a, first, the lower electrode layer 330 made of a soft-magnetic conductive material such as NiFe, CoFeNi, CoFe, FeN or FeZrN with a thickness of approximately 0.3 to 5 μm is formed on/above the element formation surface of the slider wafer substrate by using, for example, a frame plating method (step S1). Next, on the lower electrode layer 330, sequentially formed are the lower metal layer 40 made of such as Ta, Hf, Nb, Zr, Ti, Mo or W with a thickness of approximately 0.5 to 7 nm, the base layer 41 made of such as NiCr or NiFe with a thickness of approximately 3 to 8 nm, the antiferromagnetic layer 42 made of such as IrMn, PtMn, NiMn or RuRhMn with a thickness of approximately 3 to 18 nm, the first ferromagnetic film 43a made of such as CoFe with a thickness of approximately 1 to 4 nm, the non-magnetic film 43b made of such as Ru, Rh, Ir, Cr, Re or Cu with a thickness of approximately 0.5 to 2 nm, and the second ferromagnetic film 43c made of such as CoFe with a thickness of approximately 1 to 5 nm, by using, for example, a sputtering method (step S2).

Then, the base film made of a metal such as Al, Mg, Ti, Hf, Zn, Ta, Zr, Mo, W, Sn, Ni, Gd, Nb, Ga or Ge, or Si is formed on the formed second ferromagnetic film 43c by using, for example, a sputtering method (step S3). Here, the important feature of the present invention will be explained by using FIG. 4b. The layer thickness of the tunnel barrier layer 44 at which the resistance-change ratio of the TMR effect element 33 indicates a maximum value is defined to be t_{ML0}, as described above. And the film thickness of the base film at which the layer thickness t_{ML0} of the tunnel barrier layer 44 is obtained is defined to be t_{MF0} when only the film thickness t_{MF} of the base film is changed with the oxidization condition held constant. Then, the film thickness t_{MF} of the base film according to the present invention is set to be larger than the film thickness t_{MF0}. Specifically, in the case that an Al film is used as the base film, the film thickness t_{MF} is set to be in the range of 0.50 nm to 1.5 nm. In the case that a Mg film is used as the base film, the film thickness t_{MF} is set to be in the range of 0.60 nm to 1.5 nm.

Here, the film thickness t_{MF} setting of exceeding the film thickness t_{MF0} will be explained. Conventionally, the layer thickness of the tunnel barrier layer has been adjusted so that the ratio of the resistance-change ratio and the sheet-resistance of the element becomes as high as possible, as described above. Generally, the higher the ratio is, the larger the element output becomes. In fact, a base film with a thickness at which the resistance-change ratio indicates a maximum value or with smaller thickness than the just-described thickness has been used. In the case of using the base film with such a film thickness, there has been a problem that a noise, especially a high temperature noise or a low temperature noise, is likely to occur by a mechanism described later. On the contrary, the setting to the sufficiently large thickness t_{MF}, which is larger than the thickness t_{MF0}, of the base film according to the present invention can suppress the noise such as the high temperature noise and the low temperature noise.

Next, returning to FIG. 4a, the oxidization process of the base film is performed (step S4) by exposing the upper surface of the formed base film in an atmosphere of, for example, an oxidization chamber with a predetermined O₂ (oxygen) partial pressure of, for example, 1 to 1000 Pa (pascal). The oxidization process may be namely a natural oxidization process in which O₂ gas alone or the mixture of O₂ gas and cleanup gas is introduced in, for example, the oxidization chamber until the chamber is filled with the introduced gas with a predetermined pressure, or may be a flow oxidization process in which O₂ gas alone or the mixture of O₂ gas and cleanup gas is introduced in, for example, the oxidization chamber under the condition that the chamber is evacuated by a vacuum pump. The cleanup gas is defined as a gas making no contribution to the oxidization, such as a noble gas of He (helium), Ne (neon), Ar (argon), Kr (krypton) or Xe (xenon), a gas including N₂ (nitrogen) or H₂ (hydrogen), or the mixture gas of at least two of these gases. The tunnel barrier layer 44 is formed through the above-described oxidization process. According to FIG. 4b, the layer thickness t_{ML} of the formed tunnel barrier layer 44 becomes larger than the layer thickness t_{ML0}.

Then, returning to FIG. 4a, on the formed tunnel barrier layer 44, sequentially formed are the high polarizability film 45a made of, for example, CoFe with a thickness of approximately 0.5 to 2 nm, and the soft-magnetic film 45b made of, for example, NiFe with a thickness of approximately 1 to 8 nm, by using, for example, a sputtering method, to provide the free layer 45 (step S5). Next, on the free layer 45, formed is the upper metal layer 46 made of, for example, Ta, Ru, Hf, Nb, Zr, Ti, Cr, Mo or W with a thickness of approximately 1 to 20 nm (step S5).

Next, after a photoresist pattern for a lift-off process, etc. is formed on the upper metal layer 46, the formed multilayer is patterned by etching such as an ion milling method. Here, in the case of an embodiment including the above-described hard bias means, after a insulating film and a hard-magnetic film are deposited, the insulating layer 48 and the hard bias layer 47 are formed by removing the photoresist pattern, that is, by using a lift-off method (step S6). Then, by further patterning process, the TMR effect multilayer 332 is formed, and further the insulating layer 333 is formed (step S6). At the last, on the formed TMR effect multilayer 332, formed is the upper electrode layer 334 made of a soft-magnetic conductive material such as NiFe, CoFeNi, CoFe, FeN or FeZrN with a thickness of approximately 0.5 to 5 μm, by using, for example, a frame plating method (step S7). Through these processes, the TMR effect element 33 is completed.

Hereinafter, practical examples of the TMR effect element according to the present invention will be presented, and the influence of the film thickness of the base film on the high and low temperature noises will be explained.

### The Case of Al Base Film

Table 1 shows the relation of the film thickness t_{MF} of an Al base film, the resistance-change ratio and the ratio of the resistance-change ratio/the sheet-resistance in the TMR effect element in which the base film is made of Al.

TABLE 1

| Thickness t_{MF} | Sheet- | Resistance- | |
|---|---|---|---|
| of Al base | resistance RA | change ratio | (ΔR/R₀)/ |
| film (nm) | (Ωμm²) | ΔR/R₀ (%) | RA |
| 0.425 | 1.57 | 22.71 | 14.5 |
| 0.450 | 1.92 | 32.35 | 16.8 |
| 0.475 | 2.21 | 34.68 | 15.7 |
| 0.500 | 2.50 | 34.19 | 13.7 |
| 0.525 | 2.81 | 33.38 | 11.9 |
| 0.550 | 3.07 | 32.13 | 10.5 |
| 0.575 | 3.44 | 28.90 | 8.4 |

The TMR effect element used for the measurements included a multilayer in which sequentially stacked are: an antiferromagnetic layer made of IrMn with a thickness of 7 nm; a pinned layer formed by sequentially stacking a CoFe film with a thickness of 2 nm, a Ru film with a thickness of 0.8 nm and a CoFe film with a thickness of 2.5 nm; a tunnel barrier layer formed by oxidizing an Al base film; and a free layer formed by sequentially stacking a CoFe film with a thickness of 3 nm and a NiFe film with a thickness of 1 nm. The oxidization process of the Al base film is performed as the follows: the multilayer in which the Al base film was deposited at the last was set in an oxidization chamber, O₂ (oxygen) gas was introduced in the chamber, and the O₂ gas was evacuated from the chamber after sealing the O₂ gas in the chamber for a predetermined time. The resistance-change ratio ΔR/R₀ is defined as a ratio of the maximum amount ΔR of the element resistance change during applying magnetic field and the element resistance R₀. Further, the sheet-resistance RA is defined as a product R₀×Sₛ of the element resistance R₀ and the area Sₛ of the layer surface through which a sense current flows effectively. Here, the element resistance R₀ is an electric resistance in the case that an electric current flows in the direction of the layer thickness of the element. All samples had the same amount of the area Sₛ.

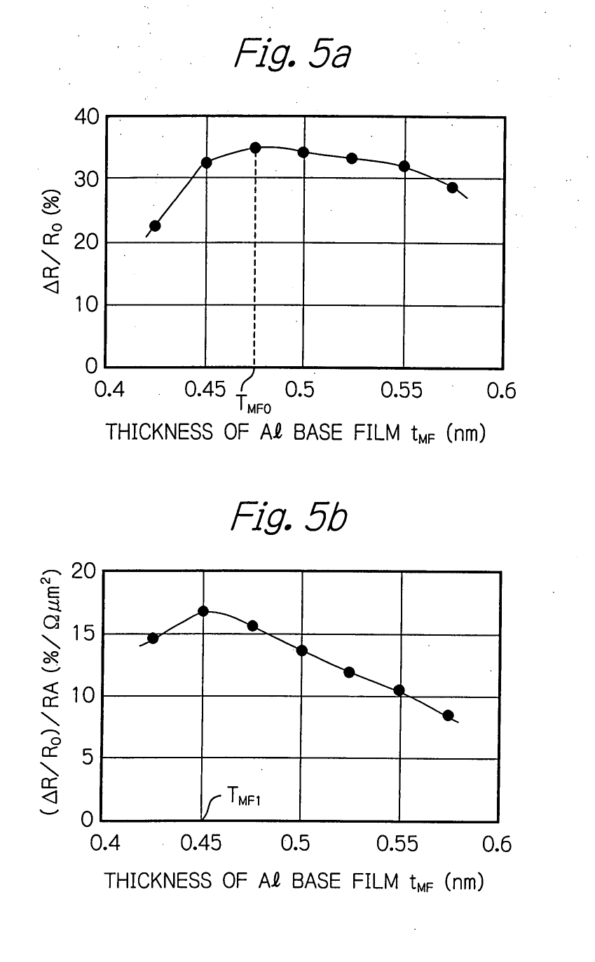

FIG. 5a shows a graph of the relation between the film thickness t_{MF} of the Al base film and the resistance-change ratio, whose data are shown in Table 1. And FIG. 5b shows a graph of the relation between the film thickness t_{MF} of the Al base film and the ratio of the resistance-change ratio/the sheet-resistance, whose data are also shown in Table 1.

As shown in FIG. 5a, the resistance-change ratio ΔR/R₀ shows a peak value of 34.68% when the film thickness t_{MF} of the Al base film is 0.475 nm being equal to t_{MF0}. While, as shown in FIG. 5b, the ratio (ΔR/R₀)/RA of the resistance-change ratio/the sheet-resistance shows a peak value of 16.8%/Ωμm² when the film thickness t_{MF} of the Al base film is 0.450 nm defined to be t_{MF1}. As described above, conventionally, the film thickness t_{MF} of the base film has been adjusted so that the ratio (ΔR/R₀)/RA of the resistance-change ratio/the sheet-resistance becomes as large as possible, that is, so that the film thickness t_{MF} becomes as close to the film thickness t_{MF1} as possible. Therefore, conventionally, base films have been used whose thickness is smaller than the t_{MF0} that is a thickness at which the resistance-change ratio indicates a maximum value. Here, it becomes evident from the experimental results under various oxidization conditions that the values of the t_{MF0} and the t_{MF1} are almost independent of the oxidization condition.

Then, the measurement results of the high temperature noise and the low temperature noise in these TMR effect elements will be shown. Table 2 shows the relation between the film thickness t_{MF} of the Al base film and the percent defective of the high temperature noise, and the relation between the film thickness t_{MF} of the Al base film and the percent defective of the low temperature noise.

TABLE 2

| Thickness t_{MF} of | Percent HTN | Percent LTN |
|---|---|---|
| Al base film | defective | defective |
| (nm) | (%) | (%) |
| 4.75 | 2.80 | 8.30 |
| 5.00 | 0.50 | 1.50 |

Here, the percent HTN defective and the percent LTN defective will be defined. First, a noise value is defined as an integral value (μVrms) of the noise in the range of 10 to 100 MHz. Next, the noise value at room temperature (25° C.) is defined to be N_{RT}, the noise value at 85° C. is defined to be N_{HT}, and the noise value at 0° C. is defined to be N_{LT}, and then, a high temperature noise dNsh(HT) and a low temperature noise dNsh(LT) are defined as follows:

dNsh(HT)=(N_{HT}−N_{RT})/N_{RT} (1)

dNsh(LT)=(N_{LT}−N_{RT})/N_{RT} (2)

When the high temperature noise dNsh(HT) exceeds 35%, the TMR effect element with the dNsh(HT) value is judged as a defective in respect to the high temperature noise. Then, a percent HTN (high temperature noise) defective is defined as a ratio of the defective among 200 element samples. Further, when the low temperature noise dNsh(LT) exceeds 35%, the TMR effect element with the dNsh(LT) value is judged as a defective in respect to the Low temperature noise. Then, a percent LTN (low temperature noise) defective is defined as a ratio of the defective among 200 element samples.

As shown in Table 2, the values of both the percent HTN and LTN defectives at the film thickness t_{MF0}=0.500 nm become excellently smaller than those at the film thickness t_{MF0}=0.475 nm. In the actually manufacturing floor of the TMR effect element, the control of the film thickness on the order of 0.1 nm is considerably difficult, and so the difference of 0.025 nm is almost a control limit. Therefore, it is understood that the high temperature noise and the low temperature noise can be sufficiently suppressed by setting the film thickness t_{MF} of the base film to be more than the t_{MF0} at which the resistance-change ratio ΔR/R₀ indicates a maximum value, specifically by setting the film thickness t_{MF} of the Al base film to be 0.500 nm or more. As just described, when the film thickness t_{MF} of the base film is set to be more than the t_{MF0}, the resistance-change ratio ΔR/R₀ is slightly decreased from the maximum value, as shown in FIG. 5a. However, the decrease is moderate compared with the decrease in the range where the film thickness t_{MF} is smaller than the t_{MF0}. For example, even when the film thickness t_{MF} of the base film is 0.55 nm, the resistance-change ratio ΔR/R₀ has an excellently large value on the order of 30%.

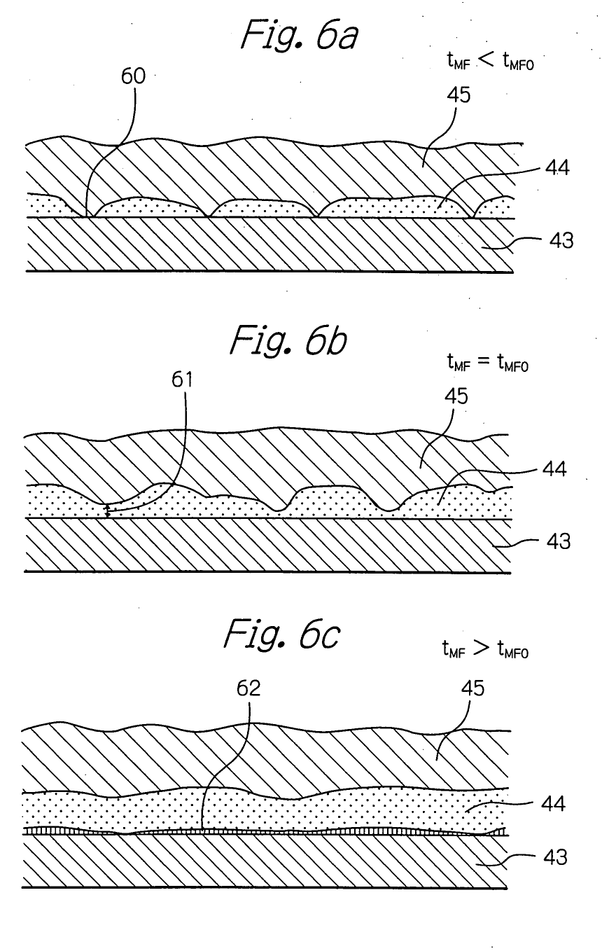

Next, a mechanism for suppressing the high and low temperature noises according to the present invention, which the present inventors have considered, will be explained. FIGS. 6a to 6c show cross-sectional views of the tunnel barrier layer 44, schematically explaining the considered mechanism. FIG. 6a is in the case that the film thickness t_{MF} of the base film is less than the t_{MF0}, FIG. 6b is in the case that the film thickness t_{MF} is equal to the t_{MF0}, and FIG. 6c is in the case that the film thickness t_{MF} is more than the t_{MF0}.

As shown in FIG. 6a, in the case that the film thickness t_{MF} of the base film is less than the t_{MF0}, in the tunnel barrier layer 44 formed by oxidizing the base film, pinholes 60 may be formed due to the insufficient film thickness. The pinhole 60 is a short-circuiting portion between the pinned layer 43 and the free layer 45, and can cause a noise as well as the reduction of the element output. Further, the pinhole 60 may cause the high and low temperature noises to be generated because the pinned layer 43 and the free layer 45 make a local magnetic coupling with each other.

As shown in FIG. 6b, in the case that the film thickness t_{MF} of the base film is equal to the t_{MF0}, the formation of the pinholes may be suppressed in the tunnel barrier layer 44. As a result, there are no short-circuiting portions between the pinned layer 43 and the free layer 45, and therefore, the reduction of the element output can be avoided. However, local thin portions still exist in the tunnel barrier layer 44. As a result, the high and low temperature noises still tend to occur due to the local magnetic couplings 61 between the pinned layer 43 and the free layer 45 formed at the local thin portions.

As shown in FIG. 6c, in the case that the film thickness t_{MF} of the base film is more than the t_{MF0}, the formation of the local magnetic coupling between the pinned layer 43 and the free layer 45, as well as the pinholes, may be avoided in the tunnel barrier layer 44 because of the sufficient layer thickness. As a result, the high and low temperature noises, as well as the noise caused by the pinholes, can be suppressed. In addition, in the oxidization process of the base film, the oxidization reaction proceeds from the upper surface of the base film. Therefore, in the case that the film thickness t_{MF} is sufficiently large as shown in FIG. 6c, a non-oxidized or insufficiently oxidized layer 62 may be formed at the lower end portion on the pinned layer 43 side of the tunnel barrier layer 44. The layer 62 causes the local magnetic couplings between the pinned layer 43 and the free layer 45 to be suppressed and effects the reduction of the element resistance.

According to the above-described mechanism, in FIG. 6a, it is considered that the increase in the resistance-change ratio ΔR/R₀ with the increase in the film thickness t_{MF} of the base film is caused by the decrease in the number of the pinholes 60. Further, it is considered that the slight decrease after passing through the peak value in the resistance-change ratio ΔR/R₀ with the further increase in the film thickness t_{MF} is caused by the formation of the non-oxidized or insufficiently oxidized layer 62.

### The Case of Mg Base Film

Table 3 shows the relation of the film thickness t_{MF} of an Mg base film, the resistance-change ratio and the ratio of the resistance-change ratio/the sheet-resistance in the TMR effect element in which the base film is made of Mg.

TABLE 3

| Thickness t_{MF} of | Sheet- | Resistance- | |
|---|---|---|---|
| Al base film | resistance | change ratio | (ΔR/R₀)/ |
| (nm) | RA (Ωμm²) | ΔR/R₀ (%) | RA |
| 0.500 | 1.30 | 55.71 | 42.9 |
| 0.550 | 1.33 | 58.30 | 43.8 |
| 0.575 | 1.35 | 59.50 | 44.1 |
| 0.600 | 1.37 | 59.45 | 43.4 |
| 0.650 | 1.40 | 59.00 | 42.1 |
| 0.700 | 1.43 | 58.15 | 40.7 |
| 0.800 | 1.49 | 56.11 | 37.7 |

The TMR effect element used for the measurements had the same structure as the above-described TMR effect element formed by using the Al base film except for the base film made of Mg. Further, the definitions of the resistance-change ratio ΔR/R₀ and the sheet-resistance RA are also the same as those explained above in Table 1.

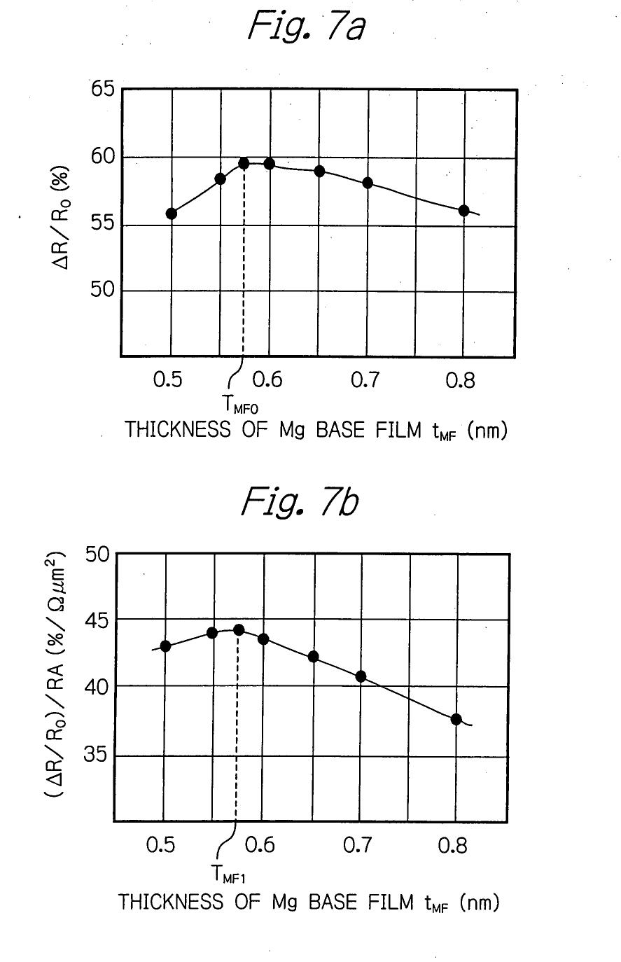

FIG. 7a shows a graph of the relation between the film thickness t_{MF} of the Mg base film and the resistance-change ratio, whose data are shown in Table 3. And FIG. 7b shows a graph of the relation between the film thickness t_{MF} of the Mg base film and the ratio of the resistance-change ratio/the sheet-resistance, whose data are also shown in Table 3.

As shown in FIG. 7a, the resistance-change ratio ΔR/R₀ shows a peak value of 59.50% when the film thickness t_{MF} of the Mg base film is 0.575 nm being equal to t_{MF0}. While, as shown in FIG. 7b, the ratio (ΔR/R₀)/RA of the resistance-change ratio/the sheet-resistance shows a peak value of 44.1%/Ωμm² when the film thickness t_{MF} of the Al base film is 0.575 nm defined to be t_{MF1}. That is, in the case of the Mg base film, the film thickness t_{MF0} and the film thickness t_{MF1} almost correspond with each other. As described above, conventionally, the film thickness t_{MF} of the base film has been adjusted so as to become as close to the film thickness t_{MF1} as possible. Therefore, conventionally, base films have been used whose thickness is the same or almost same as the t_{MF0} that is a thickness at which the resistance-change ratio indicates a maximum value. Here, it becomes evident from the experimental results under various oxidization conditions that the values of the t_{MF0} and the t_{MF1} are almost independent of the oxidization condition, also in the case of the Mg base film.

Then, the measurement results of the high temperature noise in these TMR effect elements will be shown. Table 4 shows the relation between the film thickness t_{MF} of the Mg base film and the percent HTN (high temperature noise) defective.

TABLE 4

| Thickness t_{MF} of | |
|---|---|
| Mg base film | Percent HTN |
| (nm) | defective (%) |
| 0.575 | 14.0 |
| 0.600 | 8.0 |
| 0.650 | 5.0 |
| 0.700 | 4.5 |

Here, the definition of the percent HTN defective is the same as that explained above in Table 2.

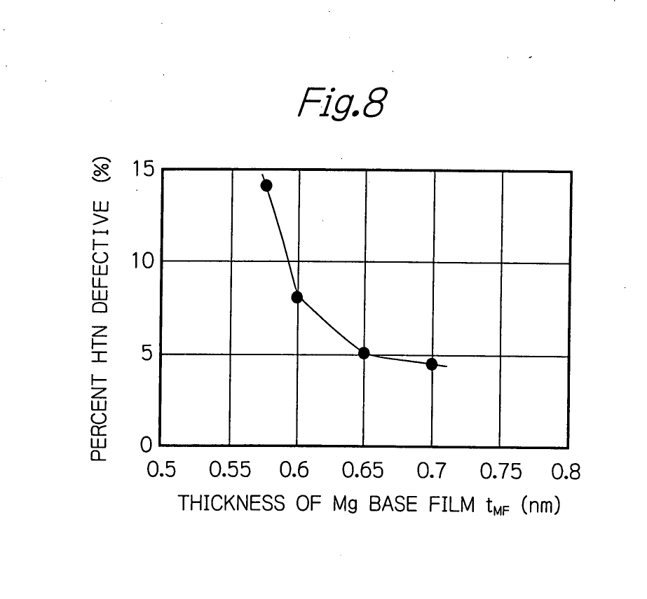

FIG. 8 shows a graph of the data shown in Table 4, that is, of the relation between the film thickness t_{MF} of the Mg base film and the percent HTN defective.

As shown in FIG. 8, the value of the percent HTN defective becomes 14.0% at the film thickness t_{MF0}=t_{MF1}=0.575 nm, 8.0% at the film thickness t_{MF}=0.600 nm, and 5.0% at the film thickness t_{MF}=0.650 nm, and shows a behavior to become asymptotic to a small value in the range over these film thicknesses. Therefore, it is understood that the high temperature noise can be sufficiently suppressed by setting the film thickness t_{MF} of the Mg base film to be more than the t_{MF0} at which the resistance-change ratio ΔR/R₀ indicates a maximum value, as well as in the case of using the Al base film, specifically by setting the film thickness t_{MF} of the Mg base film to be 0.600 nm or more. Further, as is the case of using the Al base film, when the film thickness t_{MF} of the base film is set to be more than the t_{MF0}, the decrease in the resistance-change ratio ΔR/R₀ is moderate, as shown in FIG. 7a. For example, even when the film thickness t_{MF} of the base film is 0.8 nm, the resistance-change ratio ΔR/R₀ has an excellently large value on the order of 50%.

As described above, the result about the regulation of the base film thickness t_{MF} is common between the cases of the Al and Mg base films, which supports the validity of the above-described mechanism for suppressing the high and low temperature noises. Further, according to the mechanism, the high and low temperature noises are considered to be greatly dependent on the base film thickness (on the thickness of the tunnel barrier layer) rather than the oxidization condition, which gives an understanding for the above-described result that the values of the t_{MF0} and t_{MF1} are almost independent of the oxidization condition.

In addition, in both cases of using the Al and Mg base films, it has been understood that, when the film thickness t_{MF} exceeds 1.5 nm, another noise may be induced due to the degradation of the flatness of the upper surface of the tunnel barrier layer after oxidization. Further, the larger thickness t_{MF} causes the significant generation of a shot noise, as well as the reduction of the element output due to the great increase in the element resistance. Therefore, the film thicknesses t_{MF} of the Al and Mg base films are required to be set to 1.5 nm or less.

All the foregoing embodiments are by way of example of the present invention only and not intended to be limiting, and many widely different alternations and modifications of the present invention may be constructed without departing from the spirit and scope of the present invention. In fact, the TMR effect element according to the present invention has applicability to magneto-sensitive parts of magnetic sensors, magnetic switches, magnetic encoders and so on, as well as the read head element of the thin-film magnetic head. Accordingly, the present invention is limited only as defined in the following claims and equivalents thereto.

1. A tunnel magnetoresistive effect element comprising:
a tunnel barrier layer formed by oxidizing a base film; and
two ferromagnetic layers stacked so as to sandwich said tunnel barrier layer,
said base film having a film thickness larger than a film thickness at which a resistance-change ratio of said tunnel magnetoresistive effect element indicates a maximum value.

2. The tunnel magnetoresistive effect element as claimed in claim 1, wherein said base film is an aluminum film, and a film thickness of said aluminum film is in the range of 0.50 nanometer to 1.5 nanometer.

3. The tunnel magnetoresistive effect element as claimed in claim 1, wherein said base film is a magnesium film, and a film thickness of said magnesium film is in the range of 0.60 nanometer to 1.5 nanometer.

4. The tunnel magnetoresistive effect element as claimed in claim 1, wherein said base film is a film including at least one element selected from a group of titanium, hafnium, Zinc, tantalum, zirconium, silicon, molybdenum, tungsten, tin, nickel, gadolinium, niobium, gallium and germanium.

5. The tunnel magnetoresistive effect element as claimed in claim 1, wherein said tunnel barrier layer has a non-oxidized or insufficiently oxidized layer in the lower end portion of said tunnel barrier layer.

6. A thin-film magnetic head comprising:
a substrate; and
a tunnel magnetoresistive effect element for reading data formed on/above an element formation surface of said substrate and comprising:
a tunnel barrier layer formed by oxidizing a base film; and
two ferromagnetic layers stacked so as to sandwich said tunnel barrier layer,
said base film having a film thickness larger than a film thickness at which a resistance-change ratio of said tunnel magnetoresistive effect element indicates a maximum value.

7. The thin-film magnetic head as claimed in claim 6, wherein said base film is an aluminum film, and a film thickness of said aluminum film is in the range of 0.50 nanometer to 1.5 nanometer.

8. The thin-film magnetic head as claimed in claim 6, wherein said base film is a magnesium film, and a film thickness of said magnesium film is in the range of 0.60 nanometer to 1.5 nanometer.

9. The thin-film magnetic head as claimed in claim 6, wherein said base film is a film including at least one element selected from a group of titanium, hafnium, Zinc, tantalum, zirconium, silicon, molybdenum, tungsten, tin, nickel, gadolinium, niobium, gallium and germanium.

10. The thin-film magnetic head as claimed in claim 6, wherein said tunnel barrier layer has a non-oxidized or insufficiently oxidized layer in the lower end portion of said tunnel barrier layer.

11. A head gimbal assembly comprising:
a thin-film magnetic head comprising:
a substrate; and
a tunnel magnetoresistive effect element for reading data formed on/above an element formation surface of said substrate and comprising: a tunnel barrier layer formed by oxidizing a base film; and two ferromagnetic layers stacked so as to sandwich said tunnel barrier layer, said base film having a film thickness larger than a film thickness at which a resistance-change ratio of said tunnel magnetoresistive effect element indicates a maximum value;
signal lines for said tunnel magnetoresistive effect element; and
a support means for supporting said thin-film magnetic head.

12. The head gimbal assembly as claimed in claim 11, wherein said base film is an aluminum film, and a film thickness of said aluminum film is in the range of 0.50 nanometer to 1.5 nanometer.

13. The head gimbal assembly as claimed in claim 11, wherein said base film is a magnesium film, and a film thickness of said magnesium film is in the range of 0.60 nanometer to 1.5 nanometer.

14. The head gimbal assembly as claimed in claim 11, wherein said base film is a film including at least one element selected from a group of titanium, hafnium, Zinc, tantalum, zirconium, silicon, molybdenum, tungsten, tin, nickel, gadolinium, niobium, gallium and germanium.

15. The head gimbal assembly as claimed in claim 11, wherein said tunnel barrier layer has a non-oxidized or insufficiently oxidized layer in the lower end portion of said tunnel barrier layer.

16. A magnetic recording/reproducing apparatus comprising:
at least one head gimbal assembly comprising:
a thin-film magnetic head comprising:
a substrate; and
a tunnel magnetoresistive effect element for reading data formed on/above an element formation surface of said substrate and comprising: a tunnel barrier layer formed by oxidizing a base film; and two ferromagnetic layers stacked so as to sandwich said tunnel barrier layer, said base film having a film thickness larger than a film thickness at which a resistance-change ratio of said tunnel magnetoresistive effect element indicates a maximum value;
signal lines for said tunnel magnetoresistive effect element; and
a support means for supporting said thin-film magnetic head;
at least one magnetic recording medium; and
a recording/reproducing means for controlling read and write operations of said thin-film magnetic head to said at least one magnetic recording medium.

17. The magnetic recording/reproducing apparatus as claimed in claim 16, wherein said base film is an aluminum film, and a film thickness of said aluminum film is in the range of 0.50 nanometer to 1.5 nanometer.

18. The magnetic recording/reproducing apparatus as claimed in claim 16, wherein said base film is a magnesium film, and a film thickness of said magnesium film is in the range of 0.60 nanometer to 1.5 nanometer.

19. The magnetic recording/reproducing apparatus as claimed in claim 16, wherein said base film is a film including at least one element selected from a group of titanium, hafnium, Zinc, tantalum, zirconium, silicon, molybdenum, tungsten, tin, nickel, gadolinium, niobium, gallium and germanium.

20. The magnetic recording/reproducing apparatus as claimed in claim 16, wherein said tunnel barrier layer has a non-oxidized or insufficiently oxidized layer in the lower end portion of said tunnel barrier layer.

21. A manufacturing method of a tunnel magnetoresistive effect element comprising steps of:
forming a first ferromagnetic layer on/above an element formation surface of a substrate;
forming a base film having a film thickness larger than a film thickness at which a resistance-change ratio of said tunnel magnetoresistive effect element indicates a maximum value, on said first ferromagnetic layer;
forming a tunnel barrier layer by oxidizing said base film; and
forming a second ferromagnetic layer on said tunnel barrier layer.

22. The manufacturing method as claimed in claim 21, wherein an aluminum film with a film thickness in the range of 0.50 nanometer to 1.5 nanometer is formed as said base film.

23. The manufacturing method as claimed in claim 21, wherein a magnesium film with a film thickness in the range of 0.60 nanometer to 1.5 nanometer is formed as said base film.

24. The manufacturing method as claimed in claim 21, wherein a film including at least one element selected from a group of titanium, hafnium, Zinc, tantalum, zirconium, silicon, molybdenum, tungsten, tin, nickel, gadolinium, niobium, gallium and germanium is formed as said base film.
